(19) United States
(12) Patent Application Publication
(10) Pub. No.: US 2014/0122626 A1
(43) Pub. Date: May 1, 2014

(54) METHOD AND APPARATUS FOR MESSAGE CONVERSATION IN ELECTRONIC DEVICE

(71) Applicant: Samsung Electronics Co., Ltd., Suwon-si (KR)

(72) Inventor: Mohammad Nazmul ALAM, Dhaka (BD)

(73) Assignee: Samsung Electronics Co., Ltd., Suwon-si (KR)

(21) Appl. No.: 14/035,000

(22) Filed: Sep. 24, 2013

(30) Foreign Application Priority Data
Oct. 26, 2012 (KR) 10-2012-0119547

(51) Int. Cl. H04L 12/58

(52) U.S. Cl. CPC H04L 51/04
USPC 709/206

(57) ABSTRACT

An apparatus and method for message conversation in an electronic device is provided. The method includes receiving a message from a first sender, who uses multiple messaging services, through a corresponding messaging service, determining whether IDentity (ID) information of the corresponding messaging service and a user ID of the sender registered at the corresponding messaging service are mapped to ID information of the first sender registered at a receiver in a group, and, when the received message is mapped in the group, displaying the received message and messages of the mapped group in a thread.

### CROSS-REFERENCE TO RELATED APPLICATION(S)

This application claims the benefit under 35 U.S.C. §119(a) of a Korean patent application filed on Oct. 26, 2012 in the Korean Intellectual Property Office, and assigned Serial No. 10-2012-0119547, the entire disclosure of which is hereby incorporated by reference.

### TECHNICAL FIELD

The present disclosure relates to an electronic device. More particularly, the present disclosure relates to a method and an apparatus for message conversation in an electronic device.

### BACKGROUND

Based on advances in the communication field, smart phones have become widely used and applications for smart phones are being actively developed. With so many people currently using smart phones, a popular application is a Social Networking Service (SNS). Based on its popularity, more users utilize an SNS rather than an e-mail service. In operation, the SNS is an online platform for building and strengthening social relations by providing free communication and the ability to share information among users and make personal connections. Today, most SNSs are web-based services that allow the users to communicate with each other through e-mail or an instant message as well as the web. Examples of an SNS include Facebook, Twitter, Gtalk, MSN, and Whatsapp.

Most SNSs provide a thread function allowing the user to engage in a conversation with another party. The thread indicates a sequence of conversation messages or a sequence of messages in reply to a message initially uploaded to an Internet news group or discussion. This helps the user to search and understand the conversation with the corresponding party, or to participate in the discussion by searching and understanding the related discussions in a large number of new groups.

The user installs and uses a plurality of SNS applications such as Facebook, Twitter, Gtalk, MSN, and Whatsapp in the smart phone. Accordingly, the single user makes use of multiple IDentities (IDs) to access the multiple SNSs.

Further, the single user has a cell phone ID and many other networking site IDs as well as the SNS IDs.

As such, since the single user uses the SNS and the messaging service using the multiple IDs in the related art, multiple threaded message views are created between a sender and a receiver. For example, when the user sends and receives messages to and from the other party in Facebook, one message thread is created in the Facebook application. When the user runs other SNS applications (e.g., Twitter and Gtalk) with the same other party, another message thread is created.

The messages exchanged between the user and the other party through the various SNS and messaging services are managed in the multiple threaded message views. As a result, it is difficult to search and understand the conversation with the other party.

In addition, the related art does not describe message transition between the multiple service providers. Accordingly, there is a need for an improved apparatus and method for message conversation in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address the above-mentioned problems and/or disadvantages and to provide at least the advantages described below. Accordingly, an aspect of the present disclosure to provide a method and an apparatus for message conversation in an electronic device.

Another aspect of the present disclosure is to provide a method and an apparatus for managing messages of multiple messaging services using a single thread in an electronic device.

Yet another aspect of the present disclosure is to provide a method and an apparatus for providing transition between multiple service providers in an electronic device.

According to an aspect of the present disclosure, a method for message conversation in an electronic device is provided. The method includes receiving a message from a first sender, who uses multiple messaging services, through a corresponding messaging service, determining whether IDentity (ID) information of the corresponding messaging service and a user ID of the sender registered at the corresponding messaging service are mapped to ID information of the first sender registered at a receiver in a group, and, when the received message is mapped in the group, displaying the received message and messages of the mapped group in a thread.

According to another aspect of the present disclosure, an electronic device is provided. The electronic device includes one or more processors, a memory, and one or more programs stored in the memory and configured for execution by the one or more processors. The one or more programs include instructions for receiving a message from a first sender, who uses multiple messaging services, via a corresponding messaging service, determining whether ID information of the corresponding messaging service and a user ID of the sender registered at the corresponding messaging service are mapped to ID information of the first sender registered at a receiver in a group, and displaying the received message and messages of the mapped group in a thread when the received message is mapped in the group.

According to yet another aspect of the present disclosure, an operating method of an electronic device is provided. The operating method includes a first operation for displaying a plurality of first messages sent and received to and from a particular electronic device through a plurality of messaging services, and a second operation for, when a first gesture is detected, displaying a plurality of second messages sent and received to and from the particular electronic device through a specific one of the messaging services.

The first gesture may be a multitouch zoom-in.

The operating method may further include, after the second operation, a third operation for, when a second gesture is detected, displaying the first messages sent and received to and from a particular electronic device through the messaging services.

The second gesture may be a multitouch zoom-out.

IDentity (ID) information of a corresponding messaging service may be displayed for each received message.

The operating method may further include, during the second operation for displaying the second messages sent and received to and from the particular electronic device through the specific one of the messaging services, displaying ID information corresponding to the multiple messaging services and highlighting ID information corresponding to the specific messaging service so as to indicate that the second messages are connected to the specific messaging service.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a scenario for providing a messaging service according to an embodiment of the present disclosure;

FIG. 2 is a block diagram of an electronic device for a messaging service according to an embodiment of the present disclosure;

FIG. 3 illustrates a software module for managing instant messages from multiple service providers using a single thread according to an embodiment of the present disclosure;

FIG. 4 illustrates Identity (ID) information mapping corresponding to multiple service providers and a single sender according to an embodiment of the present disclosure;

FIG. 5 illustrates a method for mapping ID information corresponding to multiple service providers and a single sender according to an embodiment of the present disclosure;

FIGS. 6A and 6B illustrate transition from a normal view to a specific view according to an embodiment of the present disclosure;

FIGS. 7A and 7B illustrate transition from a specific view to a normal view according to an embodiment of the present disclosure; and

FIGS. 8A and 8B illustrate message movement between groups according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Various embodiments of the present disclosure provide a method and an apparatus for message conversation in an electronic device.

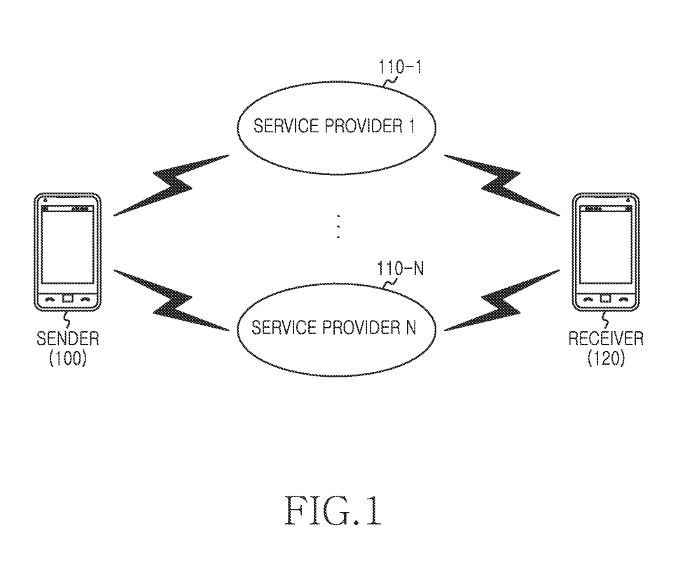

FIG. 1 illustrates a scenario for providing a messaging service according to an embodiment of the present disclosure.

Referring to FIG. 1, a sender 100 can send a message to a receiver 120 through a plurality of service providers 110-1 through 110-N. For example, the sender 100 can send an instant message to the receiver 120 using a Social Networking Service (SNS) provider 110 such as Facebook, Twitter, Gtalk, MSN, and Whatsapp. In various implementations, any or all of a text, a video, and an image file can be transmitted.

Herein, the receiver 120 classifies and displays the instant messages exchanged with the sender 100 via the different service providers 110 in one group. That is, when the receiver 120 and the sender 100 exchange instant messages using the SNS applications such as Facebook, Gtalk, MSN, and Whatsapp, the related art manages the instant messages in a single thread per SNS application. Namely, when the receiver 120 and the sender 100 exchange instant messages using Facebook, the instant messages exchanged between the receiver 120 and the sender 100 are managed in a separate thread. Likewise, when the receiver 120 and the sender 100 exchange instant messages using Gtalk, the instant messages exchanged between the receiver 120 and the sender 100 are managed in a separate thread.

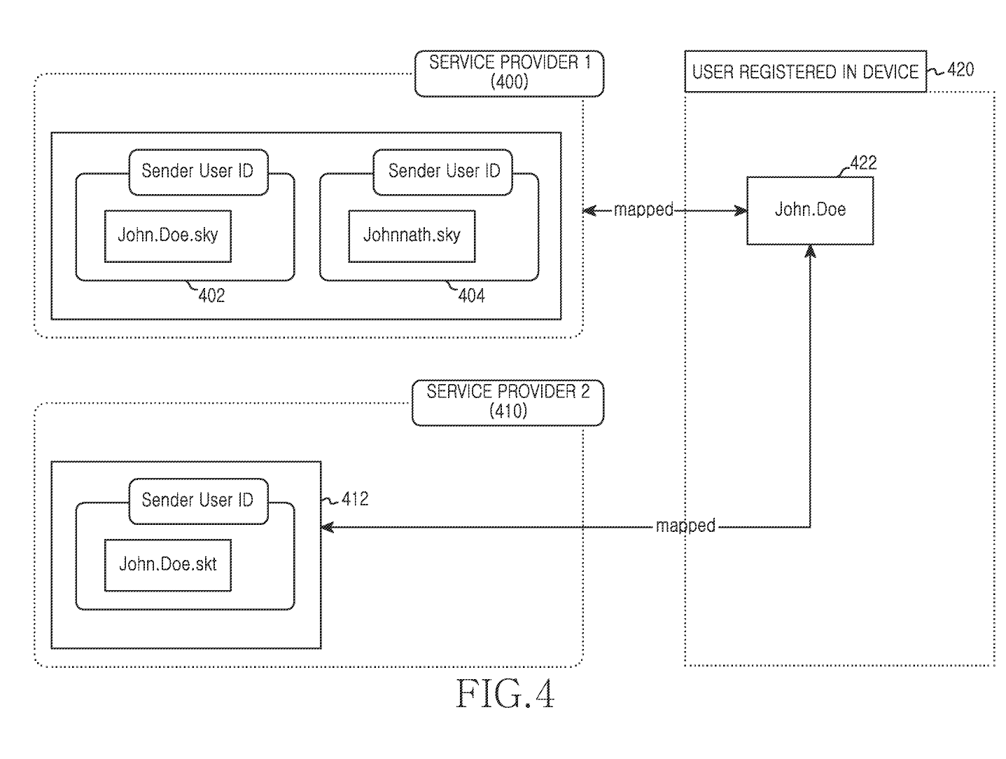

In contrast, the present disclosure predefines IDentity (ID) information corresponding to the single sender 100 who sends the instant messages through the multiple service providers 110. Hence, the instant messages via the multiple service providers 100 are mapped to the ID information corresponding to the single sender 100 and managed in a single thread. The mapping between the multiple service providers and the sender 100 registered at the receiver 120 is shown in FIG. 4.

Herein, the ID information corresponding to the single sender 100 can be directly input and registered by a user corresponding to the receiver 120. Alternatively, the ID information corresponding to the sender 100 may be received from the sender 100 and then registered.

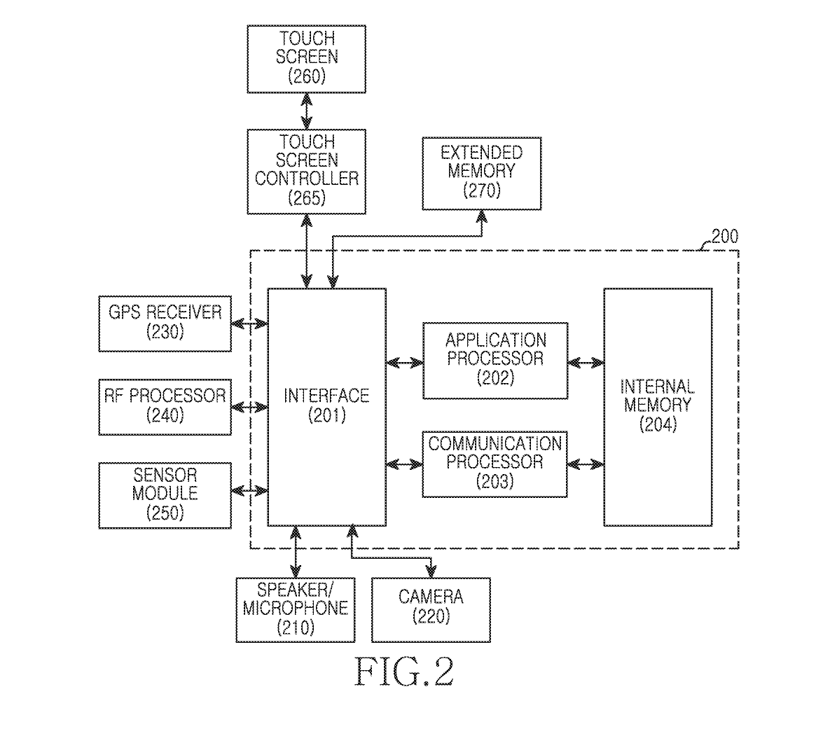

FIG. 2 is a block diagram of an electronic device for a messaging service according to an embodiment of the present disclosure.

The electronic device illustrated in FIG. 2 may be considered representative of a number of portable electronic devices such as a portable terminal, a mobile phone, a mobile pad, a media player, a tablet computer, a handheld computer, a Personal Digital Assistant (PDA), and the like. Moreover, the electronic device may be a portable electronic device combining two or more functions of those devices.

Referring to FIG. 2, the electronic device includes a controller 200, a speaker/microphone 210, a camera 220, a Global Positioning System (GPS) receiver 230, a Radio Frequency (RF) processor 240, a sensor module 250, a touch screen 260, a touch screen controller 265, and an extended memory 270.

The controller 200 can include an interface 201, one or more processors 202 and 203, and an internal memory 204. In some cases, the controller 200 may be referred to as a processor. The interface 201, the application processor 202, the communication processor 203, and the internal memory 204 can be separate components or integrated onto one or more integrated circuits.

The application processor 202 performs various functions for the electronic device by running various software programs, and the communication processor 203 processes and controls voice communication and data communication. In addition to those typical functions, the processors 202 and 203 also execute a particular software module (instruction set) stored in the extended memory 270 or the internal memory 204 and conduct particular functions corresponding to the module. That is, the processors 202 and 203 carry out the method of the present disclosure in association with software modules stored in the extended memory 270 or the internal memory 204.

According to various embodiments of the present disclosure, the application processor 202 receives a message from the sender via the corresponding service provider and obtains sender information of the received message. Herein, the application processor 202 obtains the sender information by checking a service provider ID pushing the received message and a user ID registered at the service provider. That is, the electronic device determines which service provider pushes the received message and which sender registered at the service provider sends the message. The electronic device also determines whether the service provider ID and the user ID of the sender registered at the service provider are mapped to the ID information corresponding to the sender pre-registered in the electronic device.

When the sender information is not mapped to the group, the electronic device generates a group by receiving the input from the user and maps the sender information to the group. When the sender information is mapped to the group, the electronic device stores the instant message based on group information of Equation 1 or Equation 2, described below.

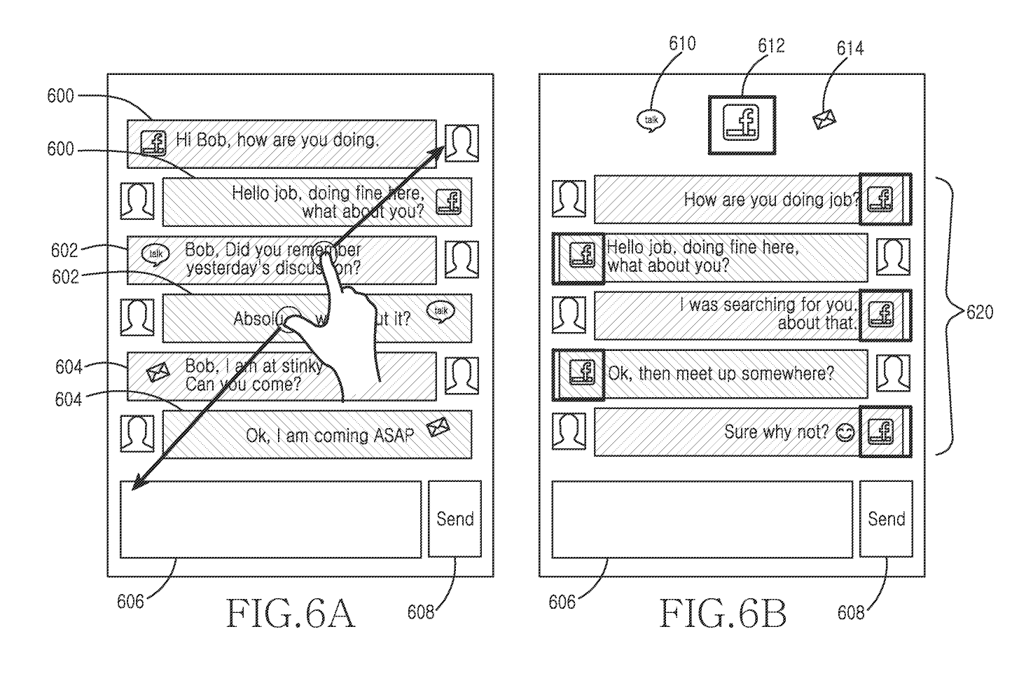

A generic message management window, such as the message management window illustrated in FIGS. 6A and 6B, displays the messages in the thread for at least one group. When a gesture is input to move the message between the groups or to transit from a first view to a second view or from the second view to the first view, the corresponding process is performed based on the gesture input. Herein, the first view displays all of the messages from the multiple service providers, and the second view displays the messages from a particular service provider.

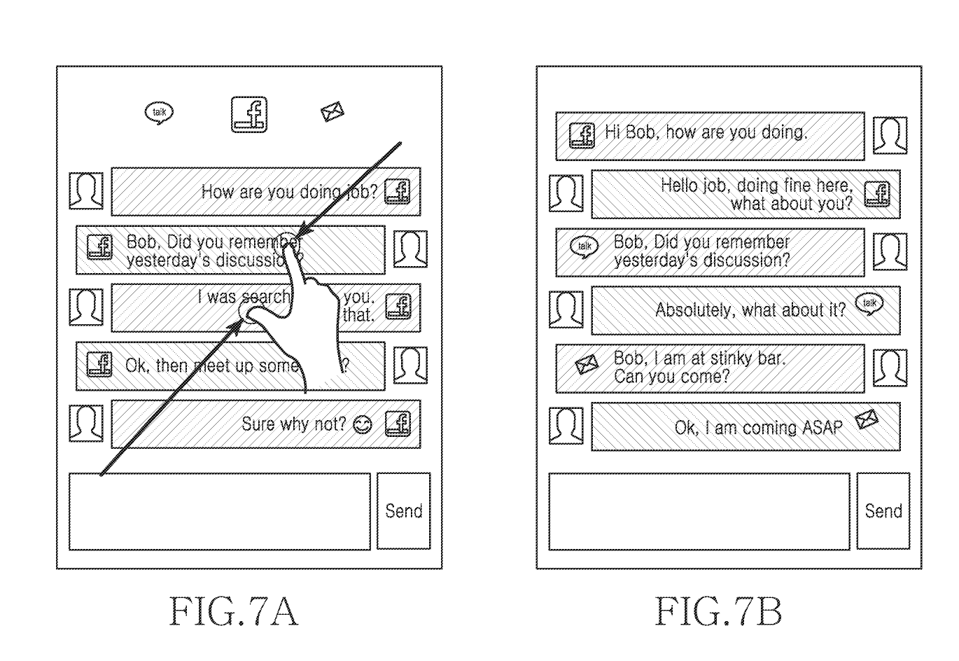

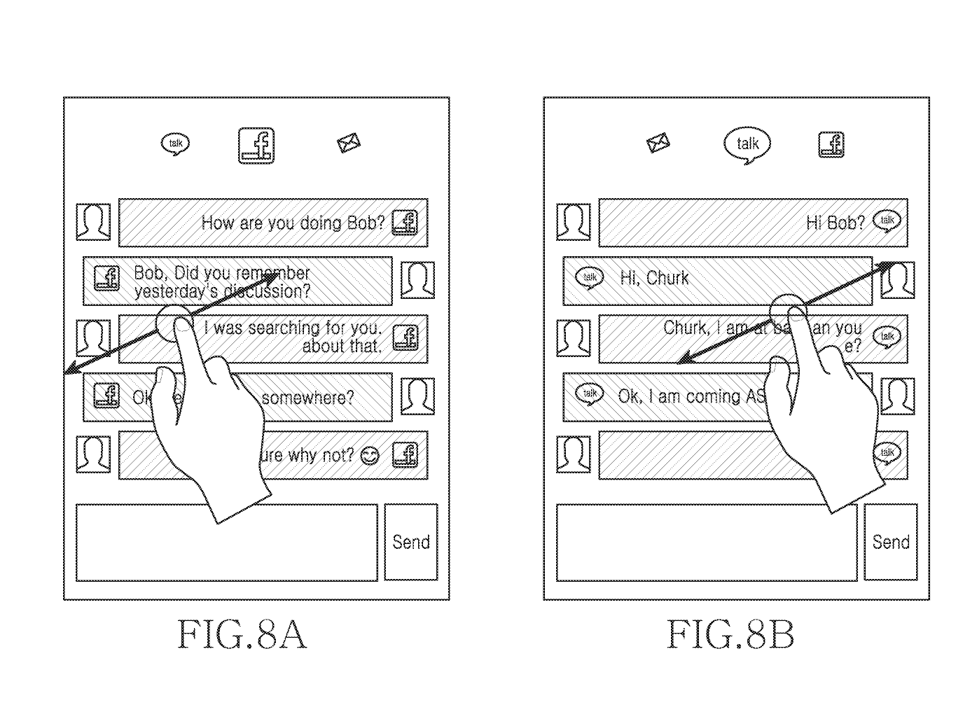

For example, when the gesture input transits from the first view to the second view as shown in FIGS. 6A and 6B, the first view is switched to the second view. When the gesture input transits from the second view to the first view as shown in FIGS. 7A and 7B, the second view is switched to the first view. When the gesture corresponding to the group movement is input as shown in FIGS. 8A and 8B, the corresponding message is moved from the first group to the second group.

The various functions of the electronic device as mentioned above and to be explained, can be executed by hardware and/or software and/or their combination including one or more signal processing and/or Application Specific Integrated Circuits (ASICs).

The interface 201 interconnects the touch screen controller 265 of the electronic device with the extended memory 270.

The sensor module 250 is coupled to the interface 201 to allow various functions. For example, a motion sensor and an optical sensor can be coupled to the interface 201 to detect a motion of the electronic device or to detect light from the outside. Besides, other sensors such as position determining system, temperature sensor, a biometric sensor, and the like can be connected to the interface 201 to conduct relevant functions.

The camera 220 is coupled to the sensor module 250 through the interface 201 to perform a camera function such as photo and video clip recording.

The RF processor 240 performs a communication function. For example, under control of the communication processor 203, the RF processor 240 converts an RF signal to a baseband signal and provides the baseband signal to the communication processor 203, or converts a baseband signal output from the communication processor 203 to an RF signal and transmits the RF signal. Herein, the communication processor 203 processes the baseband signal according to various communication schemes. For example, the communication scheme can include, but is not limited to, a Global System for Mobile communication (GSM) communication scheme, an Enhanced Data GSM Environment (EDGE) communication scheme, a Code Division Multiple Access (CDMA) communication scheme, a Wideband-CDMA communication scheme, a Long Term Evolution (LTE) communication scheme, an Orthogonal Frequency Division Multiple Access (OFDMA) communication scheme, a Wireless Fidelity (Wi-Fi) communication scheme, a WiMax communication scheme, and/or a Bluetooth communication scheme.

The speaker/microphone 210 can input and output an audio signal for voice recognition, voice reproduction, digital recording, a telephone function, and the like. That is, the speaker/microphone 210 converts a voice signal to an electric signal or converts an electric signal to a voice signal. An attachable and detachable earphone, headphone, or headset (not shown) can be connected to the electronic device through an external port.

The touch screen controller 265 can be coupled to the touch screen 260. The touch screen 260 and the touch screen controller 265 can detect a touch, a touch motion, or a change of a touch using, but not limited to, capacitive, resistive, infrared and surface sound wave techniques for determining one or more touch points with the touch screen 260 and a multitouch detection technique including various proximity sensor arrays or other elements.

The touch screen 260 provides an input/output interface between the electronic device and the user. That is, the touch screen 260 forwards a user's touch input to the electronic device. The touch screen 260 also presents the output of the electronic device to the user. That is, the touch screen 260 presents a visual output to the user. Herein, the visual output can be represented as a text, a graphic, a video, or their combination.

The touch screen 260 displays messages managed in a thread as shown in FIGS. 6A and 6B, 7A and 7B, and 8A and 8B.

The touch screen 260 can employ various types of displays, examples of which include, but are not limited to, a Liquid Crystal Display (LCD), a Light Emitting Diode (LED), a Light emitting Polymer Display (LPD), an Organic LED (OLED), an Active Matrix OLED (AMOLED), a Flexible LED (FLED), and the like.

The GPS receiver 230 converts a signal received from an artificial satellite to information such as location, speed, or time. For example, a distance between the satellite and the GPS receiver 230 can calculated by multiplying the speed of light by a signal arrival time, and a location of the electronic device may be determined using the well-known triangulation by obtaining accurate positions and distances of three satellites.

The extended memory 270 or the internal memory 204 can include fast random access memory such as one or more magnetic disc storage devices and/or non-volatile memory, one or more optical storage devices, and/or a flash memory (e.g., NAND and NOR).

The extended memory 270 or the internal memory 204 stores software. Software components include an operating system software module, a communication software module, a graphic software module, a user interface software module, an MPEG module, a camera software module, and one or more application software modules. Since the module being the software component can be a set of instructions, the module can be referred to as an instruction set. The module may be referred to as a program.

The operating system software includes various software components for controlling general system operations. The control of the general system operations includes, for example, memory management and control, storage hardware (device) control and management, and power control and management. The operating system software may process normal communication between various hardware devices and the software components (modules).

The communication software module allows communication with other electronic devices such as a computer, a server, and/or a portable terminal, through the RF processor 240. The communication software module is configured in a protocol architecture of the corresponding communication scheme.

The graphic software module includes various software components for providing and displaying graphics on the touch screen 260. The term ‘graphics’ embraces text, a webpage, an icon, a digital image, video, an animation, and the like.

The user interface software module includes various software components relating to a user interface. The user interface software module is involved in the status change of the user interface and the condition of the user interface status change.

The camera software module includes camera related software components allowing camera related processes and functions. The application module includes a browser, an e-mail application, an instant message application, a word processing application, keyboard emulation, an address book, a touch list, a widget, Digital Right Management (DRM), voice recognition, voice reproduction, a position determining function, a location based service, and the like. The memories 270 and 204 can include an additional module (instructions) in addition to the above-stated modules. Alternatively, if necessary, some of the modules (instructions) may not be used.

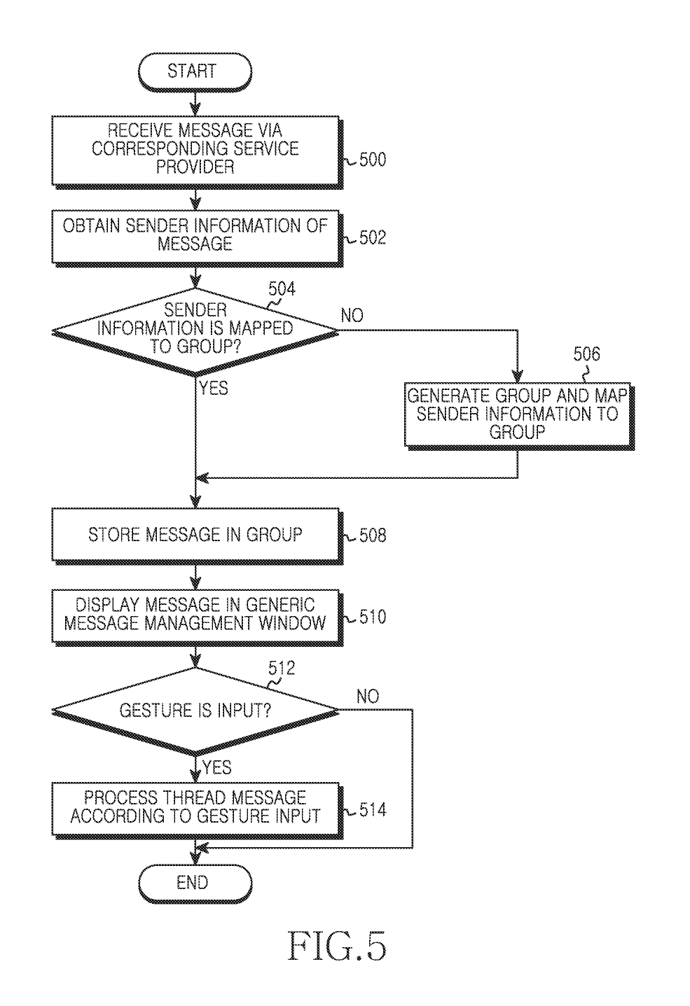

Herein, the application module includes instructions for the message conversation in the electronic device as will be described with reference to FIG. 5.

The instructions for the message conversation in the electronic device include instructions for receiving a message from the sender via the corresponding service provider, obtaining the sender information of the received message, that is, determining which service provider pushes the received message and which sender registered at the service provider sends the message, determining whether the service provider ID and the user ID of the sender registered at the service provider are mapped to the ID information corresponding to the sender pre-registered in the electronic device, generating the group by receiving the input from the user and mapping the sender information to the group when the sender information is not mapped to the group, storing the instant message based on the group information of Equation 1 or Equation 2 described below when the sender information is mapped to the group, displaying the messages in the thread for at least one group in the generic message management window of FIGS. 6A and 6B, and performing the corresponding process based on the gesture input when the gesture is input to move the message between the groups or to transit from the first view to the second view or from the second view to the first view. Herein, the first view displays all of the messages from the multiple service providers, and the second view displays the messages from a particular service provider.

The various functions of the electronic device as mentioned above and to be explained, can be executed using hardware and/or software and/or their combination including one or more signal processing and/or ASICs.

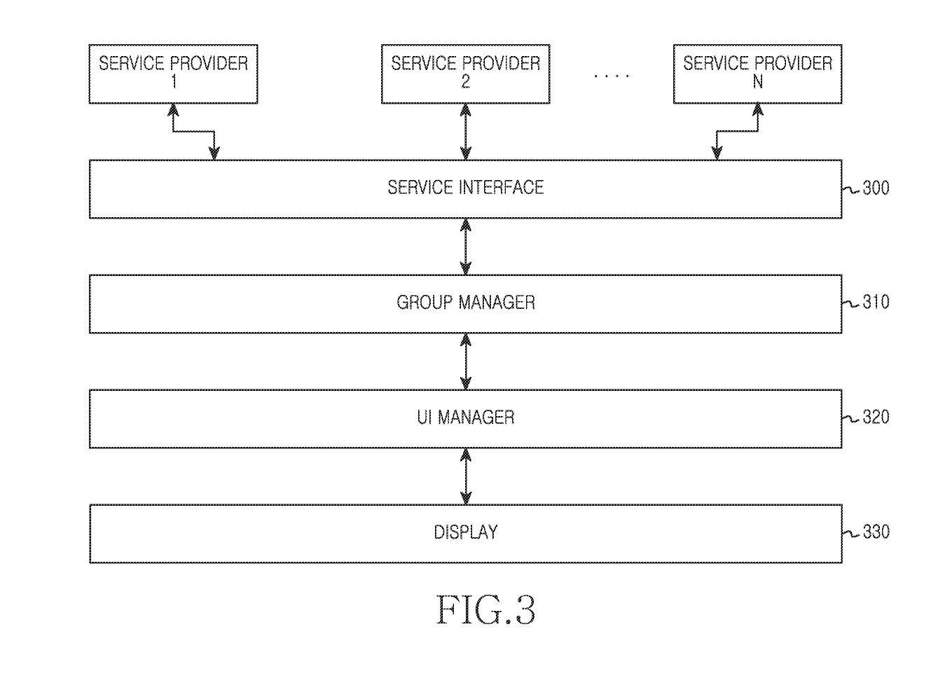

FIG. 3 illustrates a software module for managing instant messages from multiple service providers using a single thread according to an embodiment of the present disclosure.

Referring to FIG. 3, the software module includes a service interface module 300, a group manager module 310, a User Interface (UI) manager module 320, and a display module 330.

The service interface module 300 is an interface for communicating with multiple service providers, and forwards instant messages from the multiple service providers to the group manager module 310.

The group manager module 310 maps the instant messages pushed from the multiple service providers via the service interface module 300 to the ID information corresponding to the single sender. The ID information corresponding to the single sender can be directly registered by the receiver or received from the sender. For example, the group manager module 310 maps the instant messages received from the sender to the ID information corresponding to the single sender using the messaging service applications such as Facebook, Gtalk, MSN, and Whatsapp.

For example, the group manager module 310 manages the service provider (e.g., Facebook, Gtalk, MSN, Whatsapp, etc.) corresponding to the instant message received from the service interface module 300, the user ID registered by the user in the service provider, and the ID information corresponding to the registered sender, as a pair as expressed in Equation 1.

<service_provider_uid,list<service_provider_user_id,registered_sender_in_device>> Equation (1)

In Equation (1), service_provider_uid denotes a unique ID of the service provider (e.g., Facebook, Gtalk, etc.), service_provider_user_id denotes the user ID registered at the service provider, and registered_sender_in_device denotes the registered sender ID.

That is, Equation 1 can group the messages based on the service provider.

Alternatively, the messages may be managed as the pair as expressed in Equation 2.

<registered_sender_in_device,list<service_provider_uid,service_provider_user_id>> Equation (2)

In Equation (2), service_provider_uid denotes the unique ID of the service provider (e.g., Facebook, Gtalk, etc.), service_provider_user_id denotes the user ID registered at the service provider, and registered_sender_in_device denotes the registered sender ID.

That is, Equation 2 can group the messages based on the registered sender ID.

The UI manager module 320 manages the instant messages mapped by the group manager module 310 to the ID information corresponding to one sender, in the single thread. The UI manager module 320 displays the threaded messages in various styles or manages the message movement between the groups in UIs as illustrated in FIGS. 6A and 6B, 7A and 7B, and 8A and 8B.

The display module 330, under control of the UI manager module 320, displays the threaded messages in various styles.

FIG. 4 illustrates ID information mapping corresponding to the multiple service providers and a single sender according to an embodiment of the present disclosure.

Referring to FIG. 4, the message received with the user ID John.Doe.sky 402 and Johnnath.sky 404 of the sender registered at a first service provider 400 is mapped to ID information 422 of a registered user 420, and the message received with user ID John.Doe.skt 412 of the sender registered at a second service provider 410 is mapped to the ID information 422 of the registered user 420.

FIG. 5 illustrates a method for mapping ID information corresponding to multiple service providers and a single sender according to an embodiment of the present disclosure.

Referring to FIG. 5, the electronic device corresponding to the receiver receives the message from the sender via the corresponding service provider at operation 500. For example, the electronic device receives the instant message using the messaging service application such as Facebook, Gtalk, MSN, and Whatsapp.

At operation 502, the electronic device obtains the sender information of the received message. Herein, the sender information is obtained by checking the service provider ID pushing the received message and the user ID registered at the service provider. That is, the electronic device determines which service provider pushes the received message and which sender registered at the service provider sends the message.

At operation 504, the electronic device determines whether the sender information is mapped to the group. That is, the electronic device determines whether the service provider ID and the user ID of the sender registered at the service provider are mapped to the ID information corresponding to the sender pre-registered in the electronic device.

When the sender information is not mapped to the group, the electronic device generates the group by receiving the input from the user and maps the sender information to the group at operation 506. In contrast, when the sender information is mapped to the group, the electronic device proceeds to operation 508. In various implementations, the electronic device may receive the group information from the sender.

At operation 508, the electronic device stores the instant message based on the group information of Equation 1 or Equation 2.

At operation 510, the electronic device displays the threaded messages of at least one group in the generic message management window of FIGS. 6A and 6B.

When the gesture is input to move the message between the groups or to transit from the first view to the second view or from the second view to the first view at operation 512, the electronic device performs the corresponding process according to the gesture input at operation 514. Herein, the first view displays all of the messages from the multiple service providers, and the second view displays the messages from a particular service provider.

For example, when the gesture input transits from the first view to the second view as shown in FIGS. 6A and 6B, the first view is switched to the second view. When the gesture input transits from the second view to the first view as shown in FIGS. 7A and 7B, the second view is switched to the first view. When the gesture corresponding to the group movement is input as shown in FIGS. 8A and 8B, the corresponding message is moved from the first group to the second group.

In contrast, when there is no gesture input, the electronic device finishes this process.

Herein, the gesture indicates a touch pattern formed on the touch screen of the electronic device. The touch is applied onto the touch screen of the electronic device using an external input device such as a user's finger or a stylus pen, and the gesture indicates a drag in a certain pattern while touching the touch screen. In some cases, the gesture may indicate the drag from the touch up to the touch release.

In FIGS. 1 through 5, the messages pushed from the multiple service providers are mapped to the ID corresponding to the single registered sender. Alternatively, the IDs corresponding to two or more registered senders may be mapped to the messages pushed from the multiple service providers.

FIGS. 6A and 6B illustrate transition from a normal view to a specific view according to an embodiment of the present disclosure.

FIG. 6A shows a screen corresponding to a normal view, and FIG. 6B shows a screen corresponding to a specific view.

The normal view arranges and displays messages exchanged with the other party through the SNS applications such as Facebook, Gtalk, and Whatsapp on the SNS basis. In various implementations, the messages with multiple parties are arranged and displayed on the SNS basis.

For example, messages 600 are pushed from Facebook, messages 602 are pushed from Gtalk, and messages 604 are pushed from Whatsapp. The messages 600, 602, and 604 are exchanged with the same party. In various implementations, the messages 600 pushed from Facebook are sent and received to and from a first user, the messages 602 pushed from Gtalk are sent and received to and from a second user, and the messages 604 pushed from Whatsapp are sent and received to and from a third user.

Alternatively, some of the messages 600 pushed from Facebook of FIG. 6A can be from the first user, and some other messages can be from the second user.

Meanwhile, when the user makes a gesture (e.g., pinches to zoom in) in the normal view of FIG. 6A, the electronic device switches to the specific view of FIG. 6B. Herein, the gesture is not limited to the zoom-in gesture and can employ various gestures. For example, an object corresponding to the message may be double-clicked to move.

The view of FIG. 6B displays only the messages pushed from one specific SNS amongst the messages pushed from the various SNSs of FIG. 6A. For example, the specific view displays only the messages 620 pushed from Facebook among the messages pushed from the various SNSs of FIG. 6A.

At this time, icons 610, 612 and 614 of the connected SNS applications are displayed at the top of the screen. In the specific view of FIG. 6B, the Facebook application icon 612 corresponding to the messages pushed from the particular SNS is activated, and the Gtalk application icon 610 and the Whatsapp icon 614 are deactivated. In various implementations, the user can select and activate the corresponding icon. In so doing, the messages corresponding to the activated icon are displayed. For example, when the Facebook icon is deactivated and the Gtalk icon is activated, the messages pushed from Gtalk are displayed alone.

The normal view and the specific view each include a chat window 606. The user can input the message in the chat window 606 and then send the messages by pressing a Send button 608. In so doing, the normal view sends the message using one of the multiple SNS applications (e.g., Facebook, Gtalk, and Whatsapp), and the specific view sends the message using the selected SNS application (Facebook).

FIGS. 7A and 7B illustrate transition from a specific view to a normal view according to an embodiment of the present disclosure.

FIG. 7A shows a screen corresponding to the specific view, and FIG. 7B shows a screen corresponding to the normal view.

Contrary to the views illustrated in FIGS. 6A and 6B, when the user makes a gesture (e.g., pinches to zoom out) in the specific view of FIG. 7A, the electronic device switches to the normal view of FIG. 7B. Herein, the gesture is not limited to the zoom-out gesture and can employ various gestures. For example, the view can be switched by pressing the corresponding soft key or hardware key.

FIGS. 8A and 8B illustrate message movement between groups according to an embodiment of the present disclosure.

In a first specific view showing of only the messages pushed from one SNS application (e.g., Facebook) as shown in FIG. 8A, the user can drag-and-drop the corresponding message into a second specific view showing only the messages pushed from a different SNS application (e.g., Gtalk) as shown in FIG. 8B.

In various implementations, in the specific view showing only the messages pushed from one SNS application (e.g., Facebook), the user may drag-and-drop the corresponding message into the normal view showing all of the messages pushed from the multiple SNS applications.

Alternatively, the user can move the message from the corresponding position to another position in the specific view or the normal view. For example, in the specific view showing only the messages pushed from one SNS application (e.g., Facebook), when the messages corresponding to two senders are classified into the groups, the message can be moved from the group of the first sender to the group of the second sender.

As set forth above, the messages from the multiple messaging services are displayed in the single thread to thus aid the user in searching and understanding the conversation with the other party. In addition, the message transition between the multiple service providers can be achieved.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for message conversation in an electronic device, the method comprising:
receiving a message from a first sender, who uses multiple messaging services, through a corresponding messaging service;
determining whether IDentity (ID) information of the corresponding messaging service and a user ID of the sender registered at the corresponding messaging service are mapped to ID information of the first sender registered at a receiver in a group; and
when the received message is mapped in the group, displaying the received message and messages of the mapped group in a thread.

2. The method of claim 1, further comprising:
when the received message is not mapped in the group, generating ID information of the first sender;
mapping the received message in a new group based on the generated ID information of the first sender; and
displaying the received message and messages of the new group in a thread.

3. The method of claim 1, further comprising:
storing the received message in the group.

4. The method of claim 1, wherein the messages in the mapped group are received through at least one messaging service different from the corresponding messaging service.

5. The method of claim 1, further comprising:
in a first view, displaying all of first messages mapped to the ID information of the first sender and second messages mapped to ID information of at least one different sender.

6. The method of claim 5, wherein the first messages and the second messages are arranged based on a type of the messaging service.

7. The method of claim 5, further comprising:
in a second view, displaying only messages connected to a corresponding messaging service among the first messages mapped to the ID information of the first sender and the second messages mapped to the ID information of the at least one different sender.

8. The method of claim 5, further comprising:
moving messages pushed from a corresponding messaging service to a window displaying only messages pushed from a different messaging service in the first view.

9. The method of claim 5, further comprising:
moving messages pushed from multiple messaging services to the window displaying only the messages pushed from the different messaging service in the first view.

10. An electronic device comprising:
one or more processors;
a memory; and
one or more programs stored in the memory and configured for execution by the one or more processors,
wherein the program comprises instructions for receiving a message from a first sender, who uses multiple messaging services, via a corresponding messaging service, determining whether IDentity (ID) information of the corresponding messaging service and a user ID of the sender registered at the corresponding messaging service are mapped to ID information of the first sender registered at a receiver in a group, and displaying the received message and messages of the mapped group in a thread when the received message is mapped in the group.

11. The electronic device of claim 10, wherein the program further comprises instructions for generating ID information of the first sender when the received message is not mapped in the group, mapping the received message in a new group based on the generated ID information of the first sender, and displaying the received message and messages of the new group in a thread.

12. The electronic device of claim 10, wherein the program further comprises an instruction for storing the received message in the group.

13. The electronic device of claim 10, wherein the messages in the mapped group are received through at least one messaging service different from the corresponding messaging service.

14. The electronic device of claim 10, wherein the program further comprises an instruction for displaying, in a first view, all of first messages mapped to the ID information of the first sender and second messages mapped to ID information of at least one different sender.

15. The electronic device of claim 14, wherein the first messages and the second messages are arranged based on a type of the messaging service.

16. The electronic device of claim 14, wherein the program further comprises an instruction for, in a second view, displaying only messages connected to a corresponding messaging service among the first messages mapped to the ID information of the first sender and the second messages mapped to the ID information of the at least one different sender.

17. The electronic device of claim 14, wherein the program further comprises an instruction for moving messages pushed from a corresponding messaging service to a window displaying only messages pushed from a different messaging service in the first view.

18. The electronic device of claim 14, wherein the program further comprises an instruction for moving messages pushed from multiple messaging services to the window displaying only the messages pushed from the different messaging service in the first view.

19. An operating method of an electronic device, the operating method comprising:
a first operation for displaying a plurality of first messages sent and received to and from a particular electronic device through a plurality of messaging services; and
a second operation for, when a first gesture is detected, displaying a plurality of second messages sent and received to and from the particular electronic device through a specific one of the messaging services.

20. The operating method of claim 19, wherein the first gesture comprises a multitouch zoom-in.

21. The operating method of claim 19, further comprising, after the second operation:
a third operation for, when a second gesture is detected, displaying the first messages sent and received to and from a particular electronic device through the messaging services.

22. The operating method of claim 22, wherein the second gesture comprises a multitouch zoom-out.

23. The operating method of claim 19, wherein IDentity (ID) information of a corresponding messaging service is displayed for each received message.

24. The operating method of claim 19, further comprising:
during the second operation for displaying the second messages sent and received to and from the particular electronic device through the specific one of the messaging services, displaying ID information corresponding to the multiple messaging services and highlighting ID information corresponding to the specific messaging service so as to indicate that the second messages are connected to the specific messaging service.

25. A non-transitory computer-readable storage medium storing instructions that, when executed, cause at least one processor to perform the method of claim 1.
